(19) United States
(12) Patent Application Publication
(10) Pub. No.: US 2017/0099368 A1
(43) Pub. Date: Apr. 6, 2017

(54) METHODS FOR PROVIDING INTER-OPERABILITY BETWEEN DEVICE APPLICATIONS

(71) Applicant: Peter Hutter, Aspen, CO (US)

(72) Inventor: Peter Hutter, Aspen, CO (US)

(21) Appl. No.: 14/872,904

(22) Filed: Oct. 1, 2015

(51) Int. Cl. H04L 29/08; G06F 3/0482; G06F 3/0487; H04L 29/06

(52) U.S. Cl. CPC H04L 67/34; H04L 67/42; H04L 67/02; G06F 3/0482; G06F 3/0487

(57) ABSTRACT

A method for operating a user device connected to a network includes receiving in an application running on the user device a communication from another user device across the network including a link to a server on the network, activating the link to send a communication to the server, running a script on the server in response to the communication, the script determining whether a particular software application is present in the user device, opening the particular software application in the user device if it is determined that the particular software application is present in the user device, and directing the user device to a page for downloading the particular software application on an app store site associated with the device if it is determined that the particular software application is not present in the user device.

### BACKGROUND

Field of the Invention

The present invention relates to software applications running on devices such as mobile devices and to methods for providing inter-operability between software applications running on such devices.

The Prior Art

Tap is a prompt commonly used in the computing environment associated with the touch screen technology currently in use. There are links that exist in the computing environment that direct a user from one place to the other with means to return to where one started the computing experience (the Back Button). There are directive links such as “Tap To Play” and the well used Play button that starts a function such as the playing of a video or audio file. These functions are the language of the current computing environment.

There are also mobile applications (“apps”) that allow the user to take a photo or find a photo, add text to it using a variety of fonts and send it to another person using the text message systems currently in use. That such applications are popular demonstrates the need for enhanced communications through the use of images. These applications are one-way streets, in that, while the app is used to send a message, there is at present no simple way for the recipient of the message to reply to the sender utilizing the creating app without having to perform several additional steps, such as identifying and finding the received message app, downloading it from the app store, opening it on the device and then sending a reply.

### BRIEF DESCRIPTION

The present invention relates to software applications running on devices such as mobile devices and to methods for providing inter-operability between software applications running on such devices.

According to one aspect of the present invention, a method for operating a user device connected to a network includes receiving in an application running on the user device a communication from another user device across the network including a link to a server on the network, activating the link to send a communication to the server, running a script on the server in response to the communication, the script performing the functions of determining whether a particular software application is present in the user device, opening the particular software application in the user device if it is determined that the particular software application is present in the user device, and directing the user device to a page for downloading the particular software application on an app store site associated with the device if it is determined that the particular software application is not present in the user device.

According to another aspect of the present invention, a method for operating a server includes receiving across a network from a software application running in a user device a request to run a script on the server, running the script on the server, the script performing functions for determining whether a particular software application is present in the user device, starting the particular software application in the user device if it is determined that the particular software application is present in the user device, and directing the user device to a page for downloading the particular software application on an app store site associated with the device if it is determined that the particular software application is not present in the user device.

In some embodiments of the invention, the application running on the user device is a text messaging application. In some embodiments of the invention, activating the link to send a communication to the server requesting that the server run a script is accomplished by tapping a region on a touch screen on the user device associated with the link.

### BRIEF DESCRIPTION OF THE DRAWING FIGURES

FIG. 1 is a flow diagram depicting an illustrative method in accordance with the present invention.

FIG. 2 is a flow diagram depicting an illustrative process implemented in a server in accordance with an aspect of the present invention.

FIG. 3 is a flow diagram depicting an illustrative process implemented in a user device in accordance with an aspect of the present invention.

FIG. 4 is a diagram showing interaction between two user devices, a server website and an app store to illustrate the operation of certain aspects of the present invention.

### DETAILED DESCRIPTION

Persons of ordinary skill in the art will realize that the following description of the present invention is illustrative only and not in any way limiting. Other embodiments of the invention will readily suggest themselves to such skilled persons.

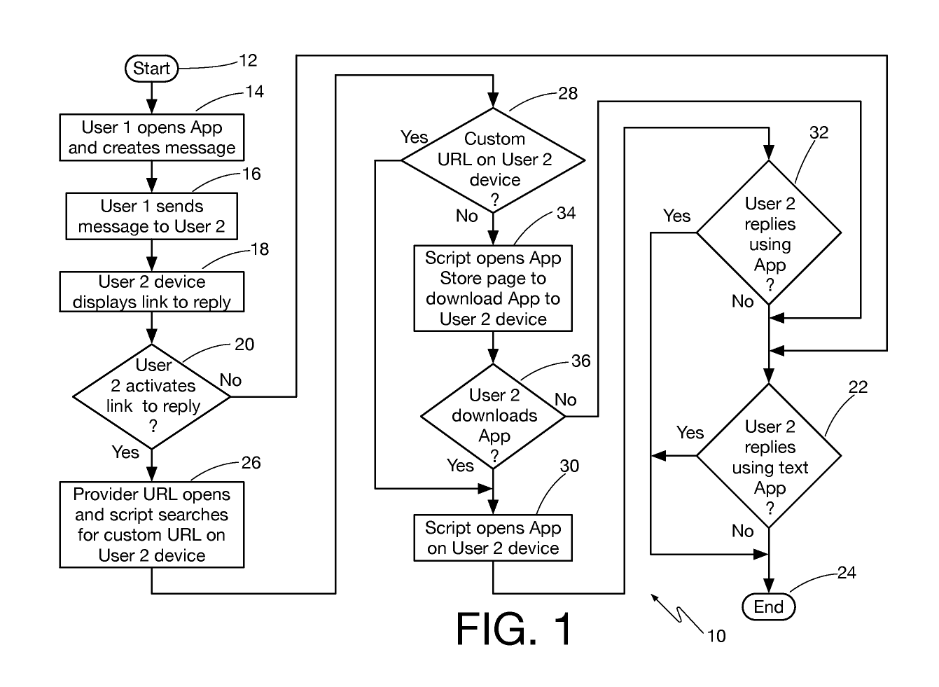

Referring first to FIG. 1, a flow diagram shows an overview of a method 10 in accordance with one aspect of the present invention. The method of FIG. 1 will be disclosed in the context of an enhanced texting app, although persons of ordinary skill in the art will readily understand its application to other social media and other apps.

The present invention relates to methods to create inter operability between software applications running on user devices, such that they may be linked to enhance the functionality of each application. User devices can include smartphones, tablets, computers, and the like.

According to one aspect of the invention, interoperability may be established between many different types of messaging applications primarily aimed at the texting platform, and is useful in communicating among a range of social platforms. The concept of the present invention may be usefully demonstrated by its function on the Kwippit™ app currently under development for the Apple iOS and the Android systems by the present inventor. The Kwippit™ App is designed to link up texting apps with the Kwippit™ App to provide enhanced functionality and allow for greater communication and enhanced emotion in the text environment beyond what is available through emojis and text on photographs.

Once published, the Kwippit™ App will be available for download from an app store such as the Apple and Android stores, and may be downloaded to a new user's phone from the app store as disclosed herein. The user is perhaps having a text conversation using, for example, SMS, MMS, and other message protocols, with a friend. At this point the user wants to punctuate the next message with a clever piece of expressive artwork or photograph along with an embedded text message. The user then chooses the Kwippit™ app from the device desktop. The app is always available from the desktop once it is downloaded to the phone. Additionally, the app is always available through the “Tap To Reply m.kwippit.com” once the Kwippit™ App is on the device. In the Kwippit™ App the user can choose from a set of expressive images that can carry with them text messages. The Kwippit™ message is created and sent normally to the text platform of another user. The other user need not have the Kwippit™ App to receive the image with the imbedded text message. The image and its embedded text message and a “link” that says “Tap To Reply m.kwippit.com” are displayed on the other user's device. The other user has the option of sending a regular text message back to the sending user, perhaps asking, “what is this”, or may tap the “Tap To Reply m.kwippit.com”.

When the “Tap To Reply m.kwippit.com” is clicked, the first action is a re-direct to a server at the Kwippit™ website through a custom URL (currently m.kwippit.com). The URL m.kwippit.com opens on the Kwippit™ website and a script such as, but not limited to, a Java, HTML, Pearl, C, Python, PHP, or ASP script instructs a search of the other user's device for the custom URL Kwippo://. If Kwippo:// is found on the device there is a redirect to launch the Kwippit™ App on that device. If Kwippo:// is not found, there is a redirect to Kwippo:// on the app store (e.g., Apple Store, Android store) and the Kwippit™ App is offered for installation on the phone. There is one line of code that is used to detect if the app exists on the user's device or not, and other code prompts the custom URL to re-direct to open the app for users that have the app installed, or to re-direct to the app store for users that do not have the app installed (for example):

<META http-equip=“refresh” content=“0;kwippo://”>

If a user has the Kwippit™ App on their device they may just tap the “Tap To Reply m.kwippit.com” link and the device jumps directly from the text app to the Kwippit™ App to send a Kwippit™ message. This allows for expressive image and text messages to be sent back and forth with ease. Selecting and composing fun messages allows the expression of greater emotion on the texting platforms where the recipient need not have the Kwippit™ App to participate.

Referring now to FIG. 1, a flow diagram depicts an illustrative method 10 in accordance with the present invention. Method 10 begins at reference numeral 12. At reference numeral 14, User 1 opens the app on a first user device and creates a message. At reference numeral 16, User 1 sends the message to User 2. At reference numeral 18, the second device used by User 2 displays the message. Included with the message is a link to reply, which may be in the form of a “touch-to-reply” button associated with the message. The user has a choice of whether or not to activate the touch-to-reply button as represented by decision diamond 20. If the user decides not to activate the touch-to-reply button, the method proceeds to reference numeral 22, where User 2 decides whether to reply to the message from User 1 using the text app. If User 2 decides to reply to the message using the text app, User 2 does so and the method ends at reference numeral 24. If at reference numeral 22, User 2 decides not to reply to the message from User 1 using the text app, the method ends at reference numeral 24.

If at reference numeral 20, User 2 decides to activate the link to reply by tapping the touch-to-reply button, the method proceeds to reference numeral 26, where the User 2 device is directed to a server on the software provider's URL. The server runs a script that interacts with the User 2 device. The script performs several tasks. First, at reference numeral 28 the script queries the User 2 device to determine if the App is resident on the User 2 device. If the app is present on the User 2 device, the method proceeds to reference numeral 30, where the script opens the App on the User 2 device. The method proceeds to reference numeral 32 where the User 2 decides whether to reply to the message from User 1 using the App. If User 2 decides to reply to the message using the App, User 2 does so and the method ends at reference numeral 24. If User 2 decides not to reply to User 1 using the App, the method proceeds to reference numeral 22, where User 2 decides whether to reply to the message from User 1 using the text app. If User 2 decides to reply to the message using the text app, User 2 does so and the method ends at reference numeral 24. If at reference numeral 22, User 2 decides not to reply to the message from User 1, the method ends at reference numeral 24.

If, at reference numeral 28 it is determined that the app is not present on the User 2 device, at reference numeral 34 the script directs the User 2 device to the app store associated with the User 2 device and to the download page containing the App. User 2 decides whether to download the App at reference numeral 36. If so the App is downloaded and is opened at reference numeral 30. The downloaded App is now present on the User 2 device and may be used whenever desired. The method proceeds to reference numeral 32 where the User 2 decides whether to reply to the message from User 1 using the App. If User 2 decides to reply to the message using the App, User 2 does so and the method ends at reference numeral 24. If User 2 decides not to reply to User 1 using the App, the method proceeds to reference numeral 22, where User 2 decides whether to reply to the message from User 1 using the text app. If User 2 decides to reply to the message using the text app, User 2 does so and the method ends at reference numeral 24.

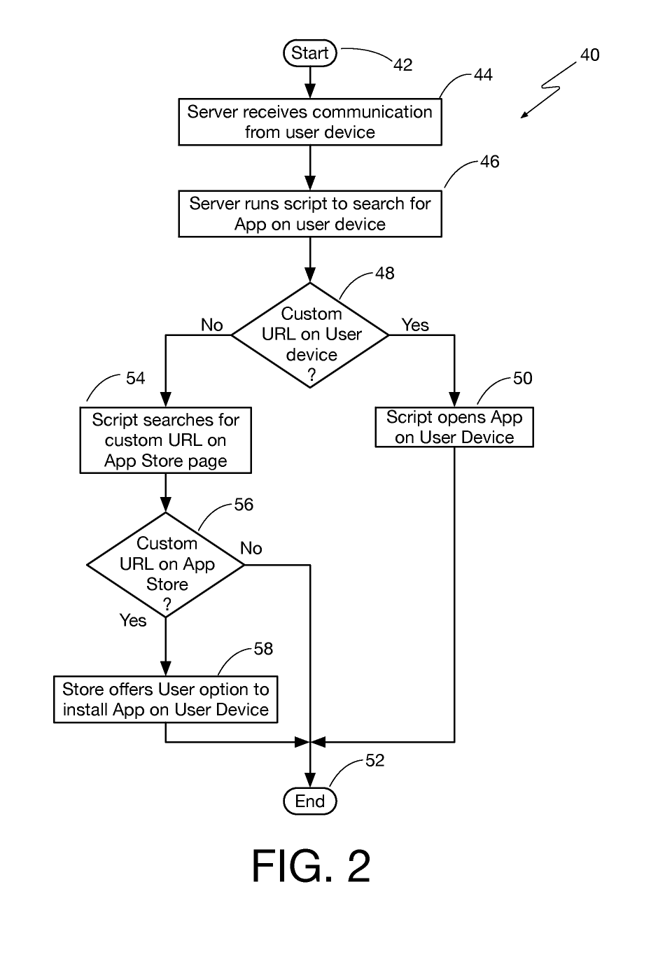

Referring now to FIG. 2, a flow diagram illustrates a method 40 from the perspective of a server maintained by the provider of the software app. The method begins at reference numeral 42. At reference numeral 44, the server receives a communication from a user device (e.g., User 2 device of FIG. 1). At reference numeral 46, the server runs a script to search for the app on the user device. As indicated at decision diamond 48, if the App is present on the user device it is opened at reference numeral 50. The method ends at reference numeral 52.

, If the App is not present on the user device, the method proceeds to reference numeral 54, where the script searches for the App on the App Store page. At reference numeral 56 if the App is not present on the App Store page the method ends at reference numeral 52. If the App is present on the App Store page, the store offers the user the option to install the App on the user's device at reference numeral 58. The method then ends at reference numeral 52. Persons of ordinary skill in the art will observe that the process performed by the server ends after serving up the store functions, and the user must then decide whether or not to download the App through the store functions.

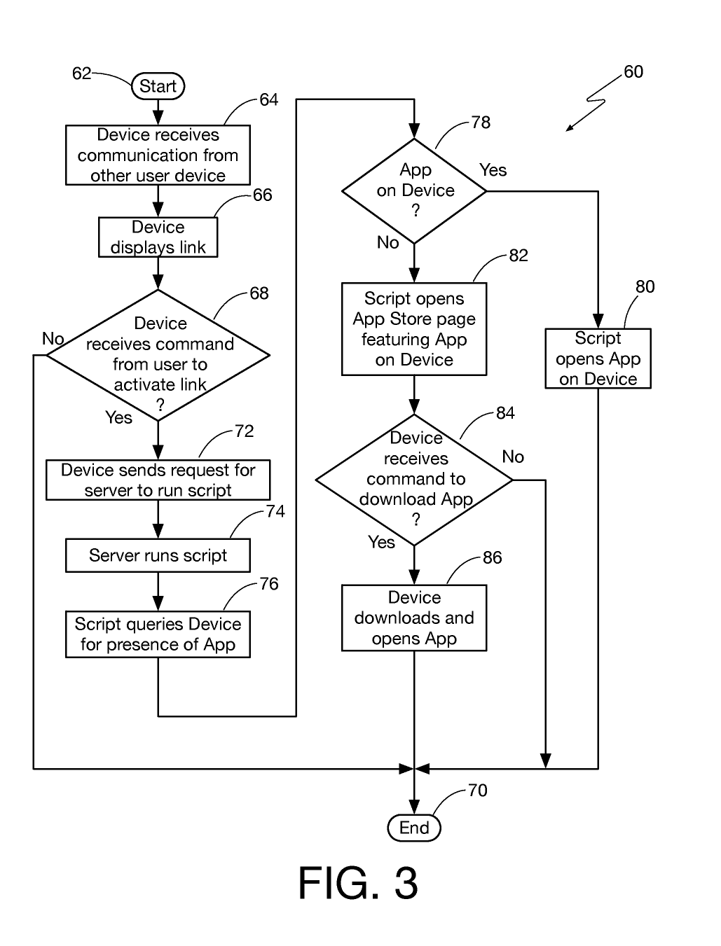

Referring now to FIG. 3, a flow diagram illustrates a method 60 from the perspective of a user device. The method begins at reference numeral 62. At reference numeral 64, the user device receives a communication from another user device. At reference numeral 66, the user device displays a link, in the form of, for example, a touch-to-reply button. At reference numeral 68, if no command (i.e., touch to respond button is tapped) is input by the user, the method ends at reference numeral 70. If, at reference numeral 68 a command is received from the user, the method proceeds to reference numeral 72, where the device sends a request to the server maintained by the provider of the software app to run a script in the server. At reference numeral 74, the script is run. At reference numeral 76 the script queries the user device to search for the App. If, at reference numeral 78, the App is found on the user device, the method proceeds to reference numeral 80, where the script opens the App on the user device. The method ends at reference numeral 70.

If, at reference numeral 78, the App is not found on the user device, the method proceeds to reference numeral 82, where the script opens on the user device the download page for the App on the app store. At reference numeral 84, if a command to download the App is input by the user, the App is downloaded to the user device and opened at reference numeral 86. The method ends at reference numeral 70. If at reference numeral 84, if a command to download the App is not input by the user, the method ends at reference numeral 70.

In one non-limiting example of the present invention, the simple use of the links and redirects in the Kwippit™ software to link up apps on phones and other devices is an advantageous feature. The Kwippit™ app on an individual device links two apps, the text app resident in a device and the Kwippit™ app. The recipient of a Kwippit™ message becomes linked through the “Tap To Reply” functionality of the sent Kwippit™ message. This allows for the recipient to easily link up their text app to Kwippit™ by downloading the Kwippit™ App from their system's app store. When Kwippit™ messages are sent to groups of users the “Tap To Reply” link create a network of friends creating emotion-enhanced communications. The posting in the Messages List of the “O Tap To Reply: m.kwippit.com” as the header for the sent Kwippit™ messages further enhances the connectivity of the apps and the conversations utilizing this system of links and redirects. In the Messages List the red emoji starts the Tap To Reply header as shown just above as an “O” and indicates the message is a Kwippit™. If one taps on the header the user goes to the message containing a Kwippit™ or Kwippits. According to one embodiment of the invention, if one further taps on one of the Kwippits the image expands to full screen and one can scroll all the Kwippits in that message.

The link ups provided by the “Tap To Reply” link its redirects, as exhibited by the use in the Kwippit™ App, may be used for other apps and groups of apps across the mobile communication platform. In accordance with the present invention, it is envisioned the “Tap To Reply” functionality could create a network of apps working together. The ability to open the sending app (e.g. Kwippit™) directly by the recipient of the Kwippit™ is missing in other apps requiring additional steps to find and download the app to use in a reply.

Using the language of the computing environment to uniquely link up the text/message communication systems with applications that enhance the base systems simply and easily is important to the “Tap To Reply” software functionality.

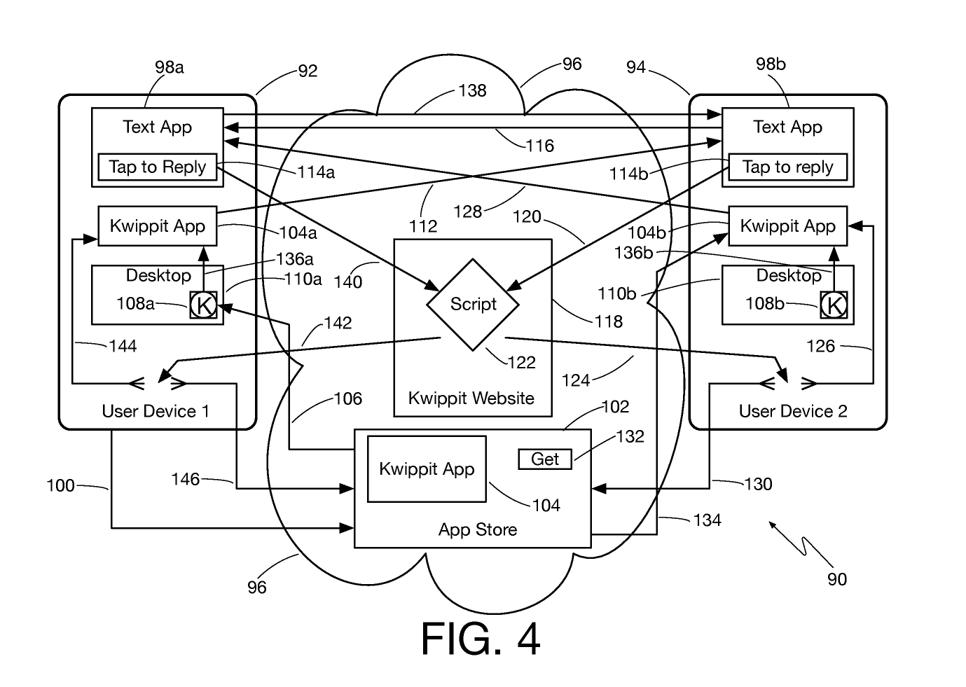

Referring now to FIG. 4, a diagram shows an exemplary interaction between two user devices, a server website and an app store to illustrate the operation of certain aspects of the present invention. The exemplary interaction depicted in FIG. 4 is in the context of the Kwippit™ App, but persons of ordinary skill in the art will appreciate that the environment depicted in FIG. 4 is only one non-limiting example of the operation of the present invention.

In FIG. 4, a network environment 90 includes a first user device 92 and a second user device 94 communicating with each other across a network indicated by cloud 96. Persons of ordinary skill in the art will appreciate that network 96 can be a wireless environment such as a cell phone network, or any other network environment. As will be appreciated by persons of ordinary skill in the art, user devices 92 and 94 may be smart phones, tablets, computers, or the like. Persons of ordinary skill in the art will appreciate that the term “user device” described in the exemplary environment described with reference to FIG. 4 is to be construed as broadly as possible to encompass devices including a processor of some sort, a display, and a means for providing user input to the device.

In the exemplary environment of FIG. 4 first user device 92 and second user device 94 are both shown running a texting application 98a and 98b, respectively. As indicated at arrow 100, the user of first user device 92 has visited the Kwippit™ App download page of the app store 102 and has downloaded the Kwippit™ App 104 (shown at arrow 106), which is now resident on first user device 92 as shown by reference numeral 104a. An icon 108a for the application is shown on desktop 110a of first user device 92 as is known in the art.

As shown at arrow 112, the first user has sent a text message to the second user using the Kwippit™ App 104a and the message is displayed in the window of the texting application 98b of the second user device 94. The message includes a “Tap-to-Reply” button indicated at reference numeral 114b.

The second user may simply reply to the text message using the texting application 98b as shown by arrow 116. Alternatively, the second user may tap the “Tap-to-Reply” button 114b. This action causes the second user device 94 to contact the Kwippit™ website 118, this action being shown by arrow 120. In response, the website 118 runs a script 122 that interacts with the second user device as indicated by arrow 124.

The script 122 queries the second user device 94 to determine the presence of the Kwippit™ App. If the Kwippit™ App (shown at reference numeral 104b) is present, the second user device 94 opens it as indicated by arrow 126, and the user of the second device may reply to the text message using the Kwippit™ App 104b as indicated by arrow 128.

If the Kwippit™ App 104b is not present in the second user device 94, the script directs the second user device 94 to the download page for the Kwippit™ App 104 in the app store 102 as indicated by arrow 130. If the user taps the “Get” button 132, the Kwippit™ App 104 is downloaded to the second user device 94 as shown by arrow 134 and may then be opened by the user of the second user device and shown on the display of the device as shown at reference numeral 104b. The icon 108b will appear on desktop 110b of the second user device 94. The user of the second device 94 may now reply to the message received by the texting app 98b from the user of the first device 92 by using the Kwippit™ App 104b as shown by arrow 128. The user may at any time open the Kwippit™ App 104b by tapping on the Kwippit™ App icon 108b on the desktop 110b of the second user device 94 as shown by arrow 136b.

In the event that the user of the second device 94 had obtained the Kwippit™ App 104b prior to the user of the first device 92, the message in the texting app 98a of the first user device 92 will show the “Tap-to-Reply” button indicated at reference numeral 114a. The user of the first user device 92 may simply reply to the text message within the texting application 98a as shown by arrow 138.

The user of the first user device 92 may also obtain his own copy 104a of the Kwippit™ App by tapping on the “Tap-to-Reply” button 114a. This action causes the first user device 92 to contact the Kwippit™ website 118, this action being shown by arrow 140. In response, the website 118 runs the script 122 that interacts with the first user device as indicated by arrow 142.

The script 122 queries the first user device 92 to determine whether the Kwippit™ App is present in the first device 92. If the Kwippit™ App 104a is present, the first user device 92 opens it as indicated by arrow 144, and the user of the first user device 92 may reply to the text message using the Kwippit™ App 104a as indicated by arrow 112.

If the Kwippit™ App 104a is not present in the first user device 92, the script 122 directs the first user device 92 to the download page for the Kwippit™ App 104 in the app store 102 as indicated by arrow 146. If the user taps the “Get” button 132, the Kwippit™ App 104 is downloaded to the first user device 92 as shown by arrow 106 and opened as shown at reference numeral 104a. The icon 108a will appear on desktop 110a of the first user device 92. The user of the first user device 92 may now reply to the message received from the user of the second device 94 by using the Kwippit™ App 104a as shown by arrow 112. The user may open the Kwippit™ App 104a by tapping on the Kwippit™ App icon 108a on the desktop 110a of the first user device 92 as previously described.

Persons of ordinary skill in the art will appreciate that operation of the Kwippit™ App discussed with reference to FIG. 4 is merely one illustrative example of the present invention and that the present invention has applications other than in the illustrative context of the Kwippit™ App discussed herein. The methods disclosed herein are intended to encompass these other applications as may be seen from the present disclosure.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for operating a server comprising:
receiving across a network from a software application running in a user device a communication including a request to run a script;
running the script, the script performing the following functions:
determining whether a particular software application is present in the user device;
opening the particular software application in the user device if it is determined that the particular software application is present in the user device; and
directing the user device to a page for downloading the particular software application on an app store site associated with the device if it is determined that the particular software application is not present in the user device.

2. A method for operating a user device connected to a network, the method comprising:
receiving in an application running on the user device a communication from another user device across the network, the communication including a link to a server on the network;
activating the link to send a communication to the server requesting that the server run a script;
running in the server a script in response to the communication to the server, the script performing the following functions:
determining whether a particular software application is present in the user device;
opening the particular software application in the user device if it is determined that the particular software application is present in the user device; and
directing the user device to a page for downloading the particular software application on an app store site associated with the device if it is determined that the particular software application is not present in the user device.

3. The method of claim 2, further comprising, in response to input on the user device from a user, downloading the particular software application from an app store site associated with the device if it is determined that the particular software application is not present in the user device.

4. The method of claim 2 wherein receiving in an application running on the user device a communication from another user device across the network, the communication including a link to a server on the network comprises receiving in a text messaging application a communication from another user device across the network.

5. The method of claim 2 wherein activating the link to send a communication to the server requesting that the server run a script comprises tapping a region on a touch screen on the user device associated with the link.

6. A method implemented on a user device including a processor, a touch screen, a device for entering input from the user, and a connection to a network, the method comprising:
receiving over the network a communication from another user device;
displaying contents of the communication on the touch screen;
displaying on the touch screen a link to a server on the network;
sensing on the touch screen an input from a user activating the link; and
sending a request to the server to run a script in response to activation of the link on the touch screen by the user, the script performing the following functions:
determining whether a particular software application is present in the user device;
opening the particular software application in the user device if it is determined that the particular software application is present in the user device; and
directing the user device to a page for downloading the particular software application on an app store site associated with the device if it is determined that the particular software application is not present in the user device.

7. The method of claim 6, further comprising:
sensing on the touch screen in the open particular application input from the user composing a response to the communication from the other user device;
appending to the response a link to the server on the network;
sending the response to the communication to the other user device across the network.

8. The method of claim 6 wherein displaying contents of the communication on the touch screen comprises displaying text on the touch screen.

9. The method of claim 7 wherein sensing on the touch screen in the open particular application input from the user composing a response to the communication from the other user device comprises sensing on the touch screen text entered by the user.
